(19) United States
(12) Patent Application Publication
(10) Pub. No.: US 2015/0055955 A1
(43) Pub. Date: Feb. 26, 2015

(54) CHANNEL MANAGEMENT METHOD IN TIME AND WAVELENGTH DIVISION MULTIPLEXING-PASSIVE OPTICAL NETWORK (TWDM-PON)

(71) Applicant: Electronics and Telecommunications Research Institute, Daejeon-si (KR)

(72) Inventors: Kwang Ok KIM, Jeonju-si (KR); Han Hyub LEE, Daejeon-si (KR); Sang Soo LEE, Dajeon-si (KR)

(21) Appl. No.: 14/468,694

(22) Filed: Aug. 26, 2014

(30) Foreign Application Priority Data
Aug. 26, 2013 (KR) 10-2013-0100836
Aug. 25, 2014 (KR) 10-2014-0110652

(51) Int. Cl. H04J 14/02; H04L 7/00; H04B 10/60; H04J 14/08

(52) U.S. Cl. CPC H04J 14/0239; H04J 14/08; H04L 7/0075; H04B 10/60
USPC 398/69

(57) ABSTRACT

The invention presents the channel management technology in a Time and Wavelength Division Multiplexing-Passive Optical network (TWDM-PON). According to an exemplary embodiment, the channel management technology is a wavelength management method for an Optical Network Unit (ONU) having a tunable receiver in the TWDM-PON in which a service is provided through multiple channels, the wavelength management method including: setting a wavelength of the tunable receiver as a first channel to receive a physical synchronization signal from an Optical Line Terminal (OLT); extracting either or both service utilization information and service operator information from the physical synchronization signal; and based on either or both of the service utilization information and the service operator information, determining whether to perform follow-up procedures for activation via the first channel or whether to change the wavelength of the tunable receiver into a second channel.

### CROSS-REFERENCE TO RELATED APPLICATION(S)

This application claims priority from Korean Patent Application Nos. 10-2013-0100836, filed on Aug. 26, 2013, and 10-2014-0110652, filed on Aug. 25, 2014, in the Korean Intellectual Property Office, the entire disclosures of which are incorporated herein by reference for all purposes.

### BACKGROUND

1. Field

This invention is about the technology of channel management in Time and Wavelength Division Multiplexing-Passive Optical Network (TWDM-PON), which employs both TDM (Time Division Multiplexing) and WDM (Wavelength Division Multiplexing) schemes.

2. Description of the Related Art

A Passive Optical Network (PON) is an optical access network connecting a central office and end users based on a point-to-multipoint link. A PON requires less central offices and optical fibers, in contrast to a point-to-point connection, so it is economically efficient.

A Time Division Multiplexing-Passive Optical Network (TDM-PON), such as Ethernet Passive Optical Network (EPON) and Gigabit capable PON (GPON), connects a central office and subscribers using a single wavelength optical signal at a downstream and upstream path. In addition, TDM-PON employs an optical splitter that does not require power consumption to connect a central office and subscribers. Due to these advantages, TDM-PON has been widely spread and used worldwide. In particular, GPON is now common across North American and European countries. In 2010, an International Telecommunications Union Telecommunication (ITU-T) has published G.987 XG-PON recommended standard and now a prototype product has been released. In addition, Full Service Access Network (FSAN), an ITU-T SG15 Q2 forum for the world's leading telecommunications services providers and equipment suppliers working toward pre-standardization, has adapted TWDM-PON as a main technology. The ITU-T is now discussing adaption of TWDM-PON as G.989.x recommended standard.

A TWDM-PON link scheme provides a broadband service to subscribers by combining the existing XG-PON scheme with a WDM scheme that enables transmission of optical signals of multiple wavelengths (e.g., four wavelengths). The multiple wavelengths may be managed or administered by the same network operator or by two or more network operators. The TWDM-PON link scheme may offer 9.95328 Gbps per downstream wavelength and 2.48832 Gbps or 9.95328 Gbps per upstream wavelength, and the system may thereby offer 40 Gbps in downstream and 10 Gbps or 40 Gbps in upstream. According to the TWDM-PON link scheme, an Optical Line Terminal (OLT) transmits four optical signals (i.e., downstream signals) with four different wavelengths, but an ONU facilitates it's a variety of tunable component to select one of the four wavelengths and receive a service using the selected wavelength.

In the TWDM-PON system, an ONU is able to select one of multiple wavelengths because the ONU needs to change and/or select a wavelength to receive the following services.
Power saving service: The TWDM-PON system may provide a service using only some multiple channels if a utilization rate of subscribers is low. In this case, an ONU needs to change a channel, if a service is no longer provided through the channel.
Load balance service: If ONUs were concentrated on a specific channel, the TWDM-PON system needs to change channels of some of the ONUs into different channels for better service quality.
Multicast service: It is required to allocate the same wavelength to an ONU group requiring a multicast service, that is, multiple ONUs, and, in this case, some of the ONUs may need to change a wavelength.

To enable an ONU to change or select a wavelength for the above services, channel identification information is required to distinguish a downstream channel from. In addition, in the TWDM-PON system, the channel identification information is included in a PHY frame periodically broadcasted by the OLT, so that the channel identification information, for example, Channel-ID, may be provided to the ONU. Based on the channel identification information, the ONU is able to identify a channel that the ONU needs to select among multiple channels.

However, to provide the above three services, that is, power saving service, load balance service, and multicast service in the TWDM-PON system, other information in addition to the channel identification information are needed. For example, considering the fact the number of ONUs or utilization rate of a service differ among the channels in the TWDM-PON system, efficient load balancing is difficult to achieve simply by using the channel identification information. In addition, in a case where the several service operators share the TWDM-PON system, a different operator may manage and administer each channel. In this case, if a channel of a specific ONU is arbitrarily determined or changed under a system policy or under the pretext of providing a service efficiently, the specific ONU may receive a service via a channel that is managed by a service operator that the ONU does not want.

### SUMMARY

The following description relates to a technology that enables efficient load balance of multiple channels in a Time and Wavelength Division Multiplexing-Passive Optical Network (TWDM-PON) system.

The following description also relates to a technology that enables a subscriber to determine a service quality and select a service operator in a TWDM-PON system shared by multiple service operators.

In one general aspect, there is provided a wavelength management method of an Optical Network Unit (ONU) having a tunable receiver in a Time and Wavelength Division Multiplexing-Passive Optical Network (TWDM-PON) in which a service is provided using multiple channels, the method including: setting a wavelength of the tunable receiver as a first channel to receive a physical (PHY) synchronization signal from an Optical Line Terminal (OLT); extracting either or both service utilization information and service operator information from the PHY synchronization signal; and based on either or both of the service utilization information and the service operator information, determining whether to perform follow-up procedures for activation via the first channel or whether to change the wavelength of the tunable receiver into a second channel.

The service utilization information and the service operator information may be contained in a Physical Synchronization Block appropriate for downstream (PSBd) header of a Framing Sublayer (FS) frame. In this case, the service utilization information and the service operator information may be contained in a PON-ID structure of the PSBd header.

The service utilization information and the service operator information may be contained in a profile Physical Layer Operation, Administration and Maintenance (PLOAM) message.

In response to the service operator information being different from service operator information stored in the ONU, the ONU may determine to change the wavelength of the tunable receiver into the second channel.

In response to the channel utilization information indicating a red state, the ONU may determine the wavelength of the tunable receiver into the second channel.

In another general aspect, there is provided a system for supporting wavelength management in a Time and Wavelength Division Multiplexing-Passive Optical Network (TWDM-PON) in which a service is provided via multiple channels, the system including: an Optical Network Unit (ONU) having a tunable receiver; and an Optical Line Terminal (OLT) configured to transmit a physical (PHY) synchronization signal to communicate with the ONU, wherein the PHY synchronization signal comprises either or both service utilization information and service operator information.

The OLT may be further configured to set a wavelength of the tunable receiver to be a first channel to receive the PHY synchronization signal; and, based on either or both the service utilization information and the service operator information, determine whether to proceed whether to perform follow-up procedures for activation via the first channel or whether to change the wavelength of the tunable receiver into a second channel.

The service utilization information and the service operator information may be contained in a Physical Synchronization Block appropriate for downstream (PSBd) header of a Framing Sublayer (FS) frame. In this case, the service utilization information and the service operator information may be contained in a PON-ID structure of the PSBd header.

The service utilization information and the service operator information may be contained in a profile Physical Layer Operation, Administration and Maintenance (PLOAM) message.

In one general aspect, there is provided an Optical Network Unit (ONU) for supporting wavelength management in a Time and Wavelength Division Multiplexing-Passive Optical Network (TWDM-PON) in which a service is provided via multiple channels, wherein the ONU is configured to comprise a tunable receiver; set a wavelength of the tunable receiver to be a first channel to receive a physical (PHY) synchronization signal from an Optical Line Terminal (OLT); extract either or both service utilization information and service operator information from the PHY synchronization signal; and, based on either or both the service utilization information and the service operator information, determine whether to perform follow-up procedures for activation using the first channel or to change the wavelength of the tunable receiver into a second channel.

The service utilization information and the service operator information may be contained in a Physical Synchronization Block appropriate for downstream (PSBd) header of a Framing Sublayer (FS) frame. In this case, the service utilization information and the service operator information may be contained in a PON-ID structure of the PSBd header.

The service utilization information and the service operator information may be contained in a profile Physical Layer Operation, Administration and Maintenance (PLOAM) message.

The ONU may be further configured to, in response to the service operator information being different from service operator information stored in the ONU, change the wavelength of the tunable receiver into the second channel.

The ONU may be further configured to, in response to the channel utilization information indicating a red state, change the wavelength of the tunable receiver into the second channel.

Other features and aspects may be apparent from the following detailed description, the drawings, and the claims.

### BRIEF DESCRIPTION OF THE DRAWINGS

FIG. 1 is a diagram illustrating an example in which channel management is required in a Time and Wavelength Division Multiplexing-Passive Optical Network (TWDM-PON).

FIG. 2 is a diagram illustrating another example in which channel management is required in a TWDM-PON.

FIG. 3 is a flow chart illustrating a channel management method in a TWDM-PON according to an exemplary embodiment.

FIG. 4A is a diagram illustrating an example of a format of a message that may be used as a physical synchronization signal.

FIG. 4B is a diagram illustrating another example of a format of a message that may be used as a physical synchronization signal.

FIG. 5 is a graph illustrating an example of a method for displaying a link utilization rate included in a physical synchronization signal.

FIG. 6A is a diagram illustrating another example of a format of a message that may be used as a physical synchronization signal.

FIG. 6B is a diagram illustrating another example of a format of a message that may be used as a physical synchronization signal.

FIG. 7 is a state machine diagram illustrating an example of part of an activation process of an Optical Network Unit (ONU).

FIG. 8 is a state machine diagram illustrating another example of part of an activation process of an ONU.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

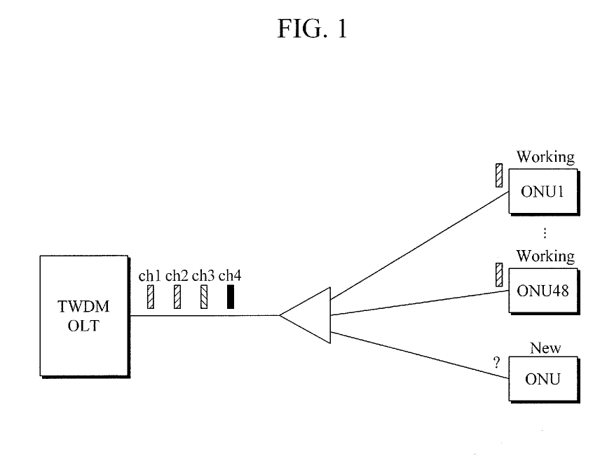

FIG. 1 is a diagram illustrating an example in which channel management is required. FIG. 1 illustrates an example in which a service is provided via four channels (ch1, ch2, ch3 and ch4) in a Time and Wavelength Division Multiplexing-Passive Optical Network (TWDM-PON), that is, an example in which four wavelengths are used for links in the TWDM-PON, but it is merely exemplary. It is assumed that Channel 1 (ch1) and Channel 2 (ch2) among the four channels in the TWDM-PON has insufficient bandwidth because ch1 and ch2 are each connected to a relatively large number of ONUs; Channel 3 (ch3) has abundant bandwidth since the number of ONUs connected thereto is small; and Channel 4 (ch4) has adequate bandwidth, as the number of ONUs connected with ch4 is between that of ch1 and that of ch2 and ch3.

In this situation, a new ONU or an existing ONU attempting to register in either ch1 or ch2, a corresponding ONU may not satisfy the contracted service level agreement. In this case, if an OLT determines that it is hard to satisfy a service quality for the ONU by using ch1 or ch2, the OLT may request the corresponding ONU to register in ch3. Of course, the request includes channel identification information of ch3. For example, in an attempt to request an ONU to change an existing channel, an OLT may transmit, to the ONU, a Tuning_Control PLOAM message including a channel identifier of a different channel. In response to receipt of the request, the ONU needs to discover a channel, whose channel identifier is identical to one that was requested, and to attempt to connect the found channel.

In the above-described scenario, an ONU has to register in one channel, and then change the channel into a different channel for re-registration, but it is inconvenient for a user. This drawback is caused by the fact that the ONU knows an amount of residual bandwidth of each channel in the TWDM-PON.

According to exemplary embodiments described in the following, in order to solve the drawback, an OLT transmits, to an ONU, information indicative of residual bandwidth of each channel, that is, channel utilization information. In this case, the OLT needs to transmit the channel utilization information until registration of the ONU in a specific channel is completed; that is, the transmission is performed during physical synchronization. In addition, in response to receipt of the channel usage rate information, based on the channel utilization information, the ONU may determine whether to register in a specific channel or whether to change the specific channel into a different channel and register in the different channel having residual bandwidth. Detailed descriptions about how to transmit channel utilization information is provided in the following.

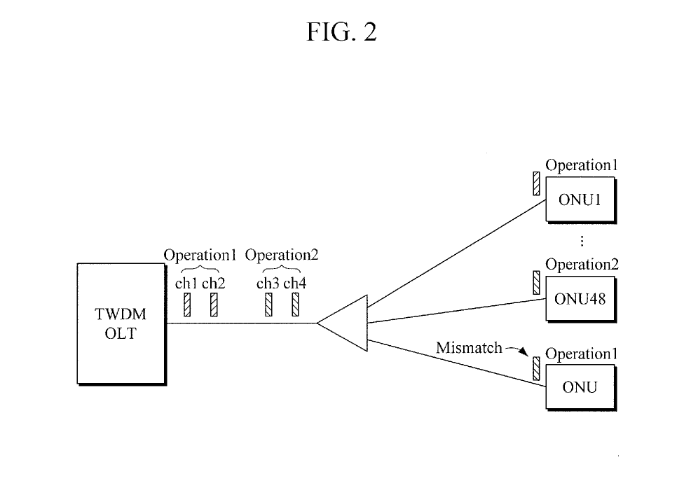

FIG. 2 is a diagram illustrating another example in which channel management is required in a TWDM-PON. In FIG. 2, a plurality of service operators, for example, two service operators, share a single TWDM-PON system having four channels ch1, ch2, ch3, and ch4. More specifically, FIG. 2 is based on the assumption that ch1 and ch2 are managed and used by Service Operator 1, whereas ch3 and ch4 are managed and used by Service Operator 2. In addition, ONU 1 receives a service via either ch1 or ch2, whereas ONU 48 receives a service via either ch3 or ch4.

Suppose that, in such an environment where a plurality of service operators share a TWDM-PON system, an ONU subscribing Service Operator 1 attempts to register in the TWDM-PON. For the registration, the ONU needs to synchronize to any one of physical (PHY) frames periodically broadcasted by OLTs in the TWDM-PON, and then attempts registration using a channel for which physical synchronization is completed. However, if it is impossible to identify a service operator of a channel during physical synchronization, the ONU may select a channel, such as ch3, which is used by a service operator that the ONU does not subscribe, such as Service Operator 2, and then may attempt registration via ch3. However, an OLT using ch3, that is, Service Operator 2, may ignore the registration request from the ONU that does not subscribe Service operator 2. In addition, an ONU may attempt re-registration via a different channel through physical synchronization. Despite the physical synchronization, if the ONU is also unable to identify a service operator of the different channel, the ONU may select ch4. However, even in this case, an OLT using ch4, that is, the second service operator, may ignore the registration request from the ONU to which it does not subscribe.

In the exemplary embodiments described in the following, an OLT transmits service operator information, which is information indicative of a service operator of each channel, to an ONU in order to solve the above drawback. The service operator information needs to be transmitted to the ONU until the ONU completely registers in a specific channel; for example, the service operator information needs to be transmitted during physical synchronization. In response to receipt of the service operator information, the ONU registers in a channel managed by a service operator to which the ONU subscribes, so that it is possible to prevent any delays in registration time. Detailed description about how to transmit service operator information is provided in the following.

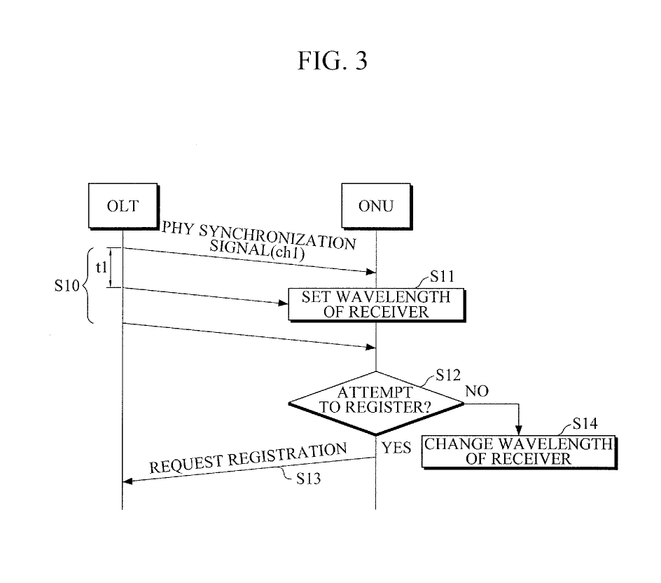

FIG. 3 is a flowchart illustrating an example of a channel management method in a TWDM-PON. In FIG. 3, an OLT is a service operator device that uses one channel (e.g., ch4) among a plurality of channels (e.g., four channels) that are usable in a TWDM-PON, and an ONU is a subscriber device that attempts to register in the TWDM-PON for the first time or to change a registered channel.

Referring to FIG. 3, an OLT broadcasts a physical synchronization signal relative to ch1 used by the OLT in S10. The physical synchronization signal may be broadcasted using a downstream wavelength allocated to ch1 at a predetermined time interval t1, for example, 125 μs. Then, the ONU may set a wavelength of a tunable receiver to be a wavelength of ch1 in S11. At this point, the ONU may be a device that attempts registration for the first time or a device that has been using a service via a channel of a different wavelength and now attempts to change the channel into ch1. After setting a wavelength of the tunable receiver to be a downstream wavelength of ch1, the ONU may receive the physical synchronization signal broadcasted by the OLT.

In response to receipt of the physical synchronization signal, the ONU extracts, from the received signal, information on the channel, channel identification information, and channel utilization information. According to an exemplary embodiment, the ONU may further extract service operator information from the received physical synchronization signal. Then, based on the extracted information, the ONU determines whether to register in a specific channel in S12. More specifically, based on the channel usage information, the ONU may determine whether to attempt to register in the specific channel. In addition, based on the service operator information, the ONU may determine whether a service operator of a specific channel is a service operator to which the ONU subscribes. If the ONU determines to register in the specific channel in S12, the ONU requests registration from the OLT and proceeds into the follow-up (e.g., follow-ups defined in the standard) in S13. Alternatively, if the ONU determines to not register in the specific channel in S12, the ONU changes a wavelength of the tunable receiver to register in a different channel in S14.

The physical synchronization signal periodically broadcasted by the OLT in S10 shown in FIG. 3 includes various kinds of information that are usually required for operation and maintenance of a physical layer. In addition, the term “physical synchronization signal” is merely exemplary, so specific types and formats of information included therein as well as the term itself may differ according to a standard applied to the TWDM-PON system. For example, a Physical Layer Operation, Operation and Maintenance (PLOAM) message including channel information may be used as a physical synchronization signal, regardless of a format thereof. However, according to an exemplary embodiment, the physical synchronization signal includes either or both service usage information and service operator information, and detailed descriptions thereof is hereinafter provided.

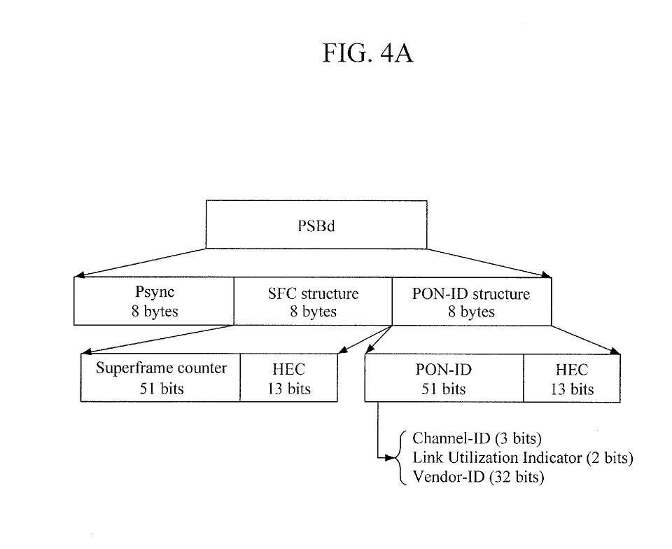

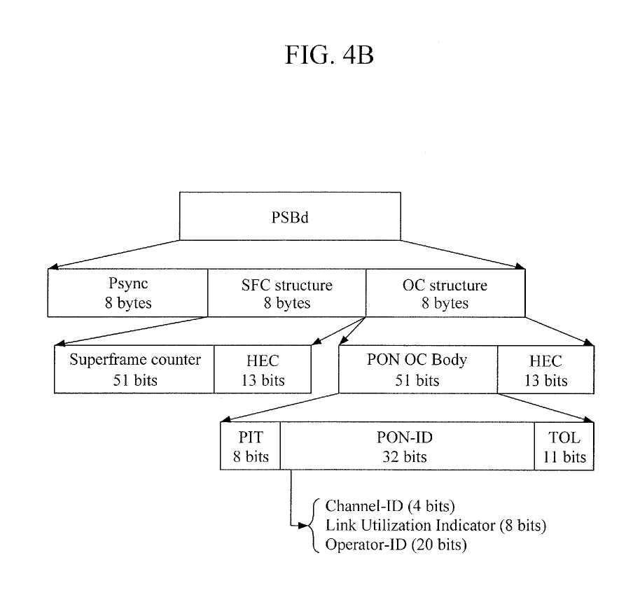

FIG. 4A is a diagram illustrating an example of a format of a message that may be used as a physical synchronization signal; that is, a diagram illustrating a structure of a Physical Synchronization Block appropriate for downstream (PSBd) header of a Framing Sublayer (FS). Referring to FIG. 4A, the PSBd header includes a Psync structure, a Super Frame Counter (SFC) structure, and a PON-ID structure. In addition, the PON-ID structure includes a PON-ID field and a Hybrid Error Correction (HEC) field. The PON-ID field may be a 64-bit field included in a downstream frame header in the ITU-T G.987.3 XG-PON standard. In the ITU-T G.987.3 XG-PON standard, 51 bits of the PON-ID field may be a field for identifying a PON port of the OLT, whereas 13 bits may be a code for providing 2-bit error correction for the 51 bits. In the example of FIG. 4A, all of the 51-bit PON-ID values are 0.

According to an exemplary embodiment, the PON-ID field includes either or both link utilization information of the channel, such as a link utilization indicator, and service operator information, such as a Vendor-ID. In addition, channel identification information, such as a Channel-ID necessary for identifying a specific channel, may be included in the PON-ID field.

FIG. 4A illustrates 3 bits for Channel-ID, 2 bits for a link utilization indicator, and 32 bits for a vendor identifier, but they are merely exemplary. For example, if 3 bits are used for Channel-ID, it is possible to distinguish eight channels (wavelengths). However, more bits may be used to distinguish more channels according to the number of channels used in the TWDM-PON system. In addition, three or more bits may be used for a link utilization indicator to distinguish link utilization among five or more link states. However, if 2 bits are used as shown in the example of FIG. 4A, link sates may be represented as below:
0x0: ONU ignores this information
0x1: Green state. That is, it represents a state in which a link utilization rate of the current channel is 30% or less.
0x2: Yellow state. That is, it is a state in which a link utilization rate of the current channel is between 30% and 70%.
0x3: Rd state. That is, it represents a state in which a link utilization rate of the current channel is 70% or more.

As illustrated in FIG. 4A, 32 bits may be used for a Vendor-ID to identify a service operator. The 32 bits are identical to the number of bits of a conventional Vendor-ID that has been used by an ONU, and thus, the same as the conventional Vendor-ID may be used as Vendor-1D in this embodiment. The ONU may select a channel by comparing Vendor-ID used thereby with Vendor-ID included in this field. If both of the two Vendor-IDs are 0, the ONU may ignore both without performing a comparison.

FIG. 4B is a diagram illustrating another example of a format of a message that may be used as a physical synchronization signal; that is, a diagram illustrating a structure of a PSBd header of an FS frame. Referring to FIG. 4B, a PSBd header includes a Psync structure, a Super Frame Counter (SFC) structure, and an OC structure. In addition, the OC structure includes a PON OC body field and a Hybrid Error Correction Field (HEC) field. For example, the PON OC body field may be included in an 8-byte OC structure, and may include a 51-bit PON OC body field and a 13-bit HEC field. The 13-bit HEC field provides 2-bit error correction for the 51-bit PON OC body field.

In addition, the PON OC body field includes a PON-ID Type (PIT) subfield, a PON-ID subfield, and a Transmit Optical Level (TOL) subfield. For example, the PON-ID subfield may be 32 bits. In this embodiment, this PON-ID subfield includes link utilization information and service operator information. The PON-ID subfield may further include channel identification information (Channel-ID).

FIG. 4B illustrates 4 bits for Channel-ID, 8 bits for a link utilization indicator, and 20 bits for Vendor-ID, but it is merely exemplary. For example, if 4 bits are used for Channel-ID, it is possible to distinguish 16 channels. However, more bits may be used to distinguish more channels according to the number of channels used in the TWDM-PON system. In addition, three or more bits may be used as a link utilization indicator to distinguish link utilization among five or more states. However, if two bits are used as shown in the example of FIG. 4B, a link state may be represented as below:
0x0: ONU does not use this information
0x1: Green state. That is, it represents a fixed level in which a link utilization rate of the current channel is 30% or less.
0x2: Yellow state. That is, it represent is a guaranteed level in which a link utilization rate of the current channel is 30-70%.
0x3: Red state. That is, it represents an additional level in which a link utilization rate of the current channel is 70% or more.

As illustrated in FIG. 4B, 20 bits may be used for Vendor-ID to identify a service operator. The ONU may compare the Vendor-ID assigned thereto with Vendor-Id included in the PON-ID subfield, and, if both match each other, may select and register in a corresponding channel.

In another example, the ONU may identify a service operator based on information included in an 8-byte PON-TAG field in a profile PLOAM message. According to one aspect of the present disclosure, only when Vendor-ID included in the PON-ID subfield is 0, an 8-byte PON-Tag field may be further used for service operator identification information, but it is merely exemplary. Generally, a profile PLOAM message is transmitted to every ONU using a broadcast ONU-ID. The PON-TAG field includes a 32-bit OLT Vendor-ID and a 32-bit Vendor Specific Serial Number (VSSN). When using the PON-TAG field, the ONU may compare a Vendor-ID assigned thereto with a Vendor-ID included in the PON TAG field and with VSSN, and, if both match each other, may select and register in a corresponding channel. If both the Vendor-ID in the PON-ID subfield and the Vendor-ID in the PON-TAG field are 0, the ONU may not use any operator identification information to select a channel.

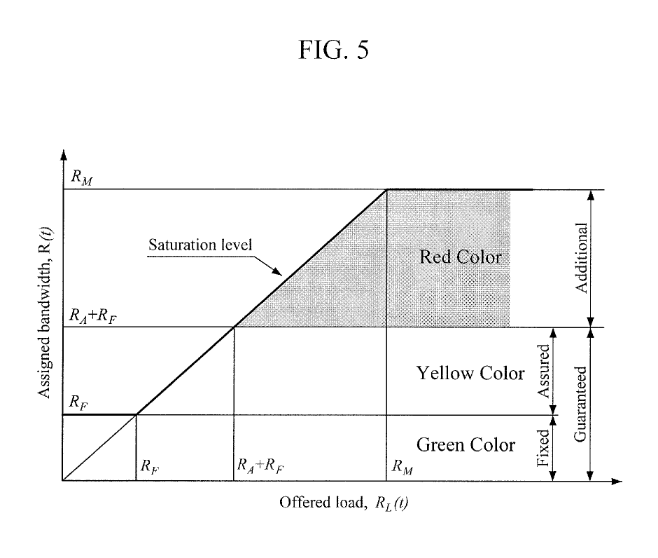

FIG. 5 is a graph illustrating an example of a method of displaying link utilization information. In FIG. 5, a vertical axis represents an assigned bandwidth for each channel; RF indicates a fixed bandwidth, RA+RF indicate a guaranteed bandwidth, and RM indicates a maximum bandwidth of a corresponding channel, which is a sum of the guaranteed bandwidth and the additional bandwidth. In addition, a horizontal axis represents offered load, that is, a bandwidth used by a corresponding channel. Referring to FIG. 5, link utilization information may be displayed in green when the offered load is less than the fixed bandwidth; in yellow when the offered load is between a minimum bandwidth and the guaranteed bandwidth; and in red when the offered load is greater than the guaranteed bandwidth.

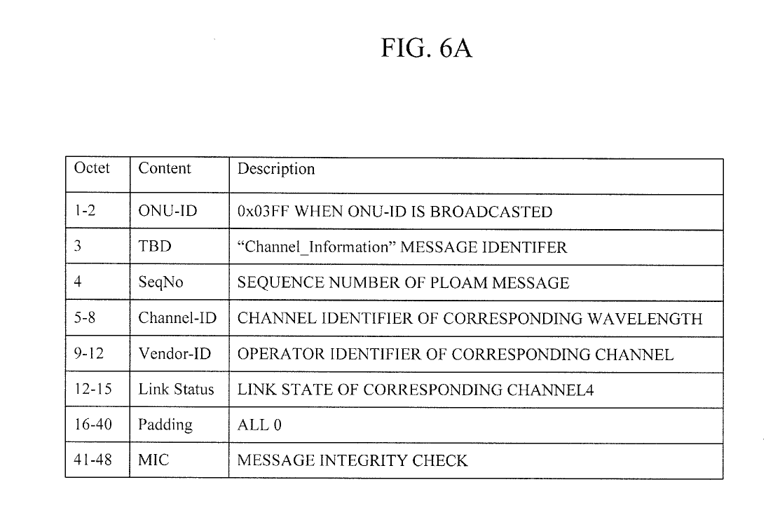

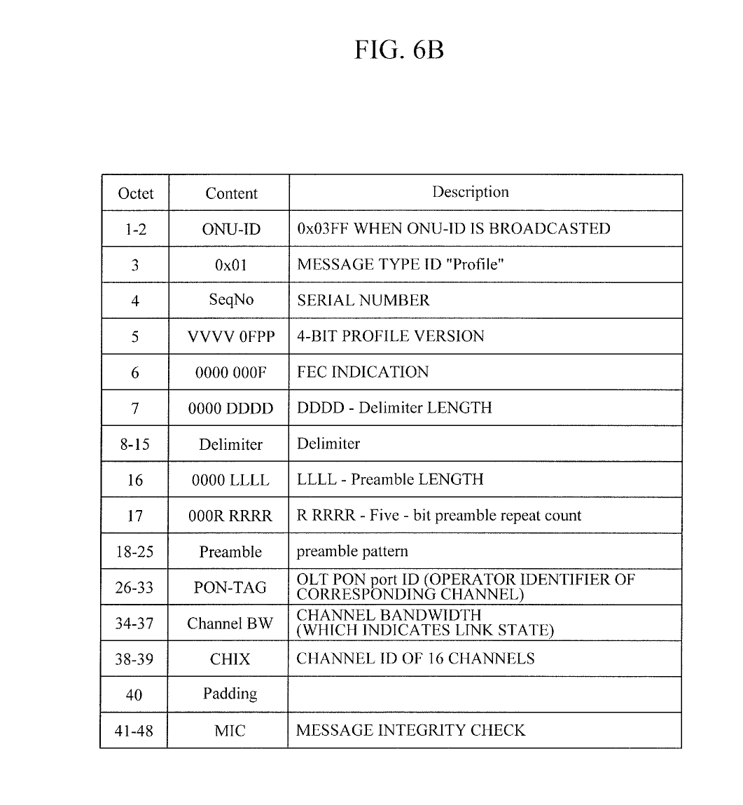

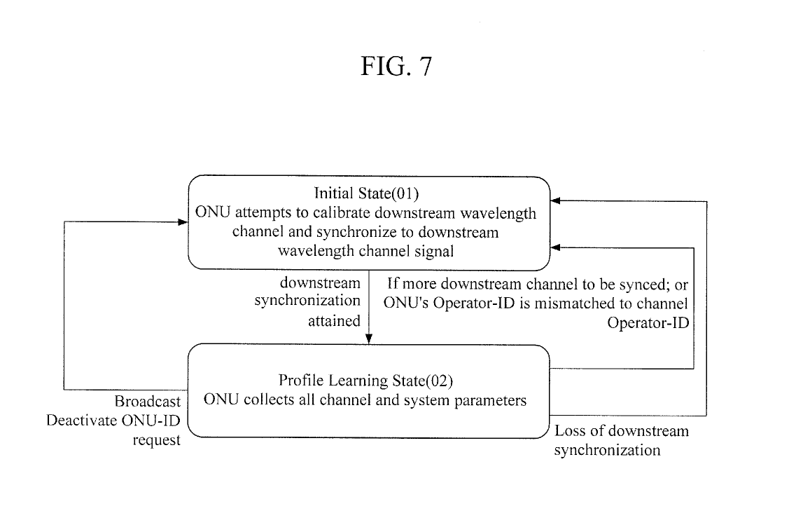

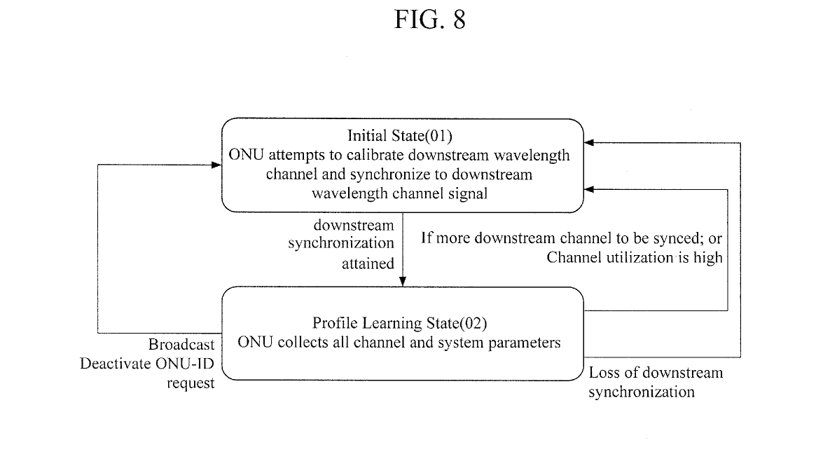

FIG. 6A is a diagram illustrating another example of a format of a message that may be used as a physical synchronization signal; that is, a table showing elements of a channel information PLOAM message. A channel information PLOAM message is a message that is broadcasted by an OLT to every ONU. Referring to FIG. 6A, the channel information PLOAM message includes link utilization information and service operator information of each channel. The channel information PLOAM message is transmitted from an OLT to ONUs before an OLT transmits an Upstream_Overhead PLOAM message to the OLT. If the ONU receives the channel information PLOAM message in a state for learning a profile (e.g., a serial number state and a profile learning state (See O2 in FIGS. 7 and 8)) after physical synchronization is completed, the ONU may extract link utilization information and/or service operator information as well as the channel identification information. Then, the ONU may use the extracted information to determine whether to continue to register in a corresponding channel.

FIG. 6B is a diagram illustrating another example of a format of a message that may be used as a physical synchronization signal; that is, a table showing elements of a channel information PLOAM message. The profile PLOAM message is a message that is transmitted from an OLT to every ONU. Referring to FIG. 6B, the profile PLOAM message include 8-byte service operator identification information required for identifying at least 16 channels, 4-byte link utilization information indicative of a bandwidth occupancy state of a channel, and 2-byte channel identification information. The 4-byte bandwidth occupancy state of a channel may indicate offered load, a utilization rate of a fixed bandwidth, a utilization rate of an assured bandwidth (See FIG. 5), and a utilization rate of an additional bandwidth. The profile PLOAM message is transmitted from an OLT to ONUs before an ONU transmits an Upstream_Overhead PLOAM message to the OLT. If the ONU receives the channel information PLOAM message in a state for learning a profile (e.g., a serial number state and a profile learning state (See O2 in FIGS. 7 and 8)) after physical synchronization is completed, the ONU may extract link utilization information and/or service operator information as well as the channel identification information. Then, the ONU may use the extracted information to determine whether to continue to register in a corresponding channel.

FIG. 7 is a state machine diagram illustrating an example of an activation process, wherein a channel is selected based on operator identification information included in a physical synchronization signal received from an OLT. Referring to FIG. 7, in response to turn-on of power or an initialization command received from an OLT, an ONU may select an arbitrary channel in an initial State (O1) to discover a physical synchronization signal or a frame synchronization signal from a downstream signal. In response to discovery of a frame synchronization signal, the ONU transitions to a profile learning state (O2). The profile learning state (O2) may be referred to as Serial Number State. In the profile learning state (O2), the ONU may read PON-ID information included in a PSBd header in a downstream FS frame, and receive profile PLOAM information.

According to the above-described embodiment, an ONU compares Operator-ID assigned thereto with Operator-ID included in a PON-ID field. If both do not match each other, the ONU recognizes that a channel corresponding to the Operator-ID included in the PON-ID field is not a channel for the ONU, and then transitions to the initial state to discover the channel for the ONU. Alternatively, if both match each other, the ONU stores a profile transmitted from the OLT and responds to a request from the OLT. The follow-up procedures are performed as defined in the relevant standard. If all operator identification information in a downstream signal are set as 0, the ONU compares the operator identification information with a PON-TAG field in a PLOAM message and selects a channel of an operator identifier matching a channel that is included in the PON-TAG field

As described above, a physical synchronization signal, that is, a downstream FS frame, transmitted from an OLT includes service operator information, and an ONU discovers and registers in a service channel therefor based on the service operator information to receive a service.

FIG. 8 is a state machine diagram illustrating another example of part of an activation process of an ONU, wherein the ONU selects a channel based on channel utilization information included in a physical synchronization signal received from an OLT. Referring to FIG. 8, in response to turn-on of power or an initialization command received from an OLT, an ONU selects an arbitrary channel in an initial state (O1) to discover a physical synchronization signal or a frame synchronization signal from a downstream signal. In response to discovery of the frame synchronization signal, the ONU transitions to a profile learning state (O2). In the profile learning state (O2), the ONU may read PON-ID information included in a PSBd header of a downstream FS frame, and may acquire channel utilization information and link utilization information of a specific channel based on the PON-ID information.

According to the above described embodiment, an ONU may check a channel utilization rate of a specific channel based on channel bandwidth information, which is the channel utilization information, included in a PON-ID field. If the channel utilization rate indicates that numerous ONUs been have registered in the specific channel and are using a service, for example, if the channel utilization information indicates a red state, the ONU may stop an activation process and return to the initial state (O1) to change the specific channel into a different channel for registration. On the other hand, if the channel utilization information indicates a green state or a yellow state, the ONU may perform an activation process with an OLT using the specific channel.

As described above, a physical synchronization signal, such as a downstream FS frame, transmitted from an OLT includes channel utilization information and the ONU, and the ONU synchronizes to and registers in a service channel having a residual bandwidth based on the channel utilization information, so that the ONU may receive a service with enough bandwidth.

According to the above described embodiment, an ONU may receive a downstream physical frame periodically broadcasted by an OLT to acquire channel identification information and service utilization information of a corresponding channel. Based on the channel identification information and the service utilization information, the ONU may establish (that is, register in) a link to the corresponding channel to receive a service or may attempt to change the corresponding channel into a different channel. By doing so, ONUs may register in multiple channels on a one to one basis, thereby achieving load balance, and thus improving service quality.

In addition, according to another exemplary embodiment, an ONU may receive a downstream physical frame periodically broadcasted by an OLT to acquire channel identification information and service operator information of a corresponding channel. Based on the channel identification information and the service operator information, the ONU may establish (that is, register in) a link to a channel provided by a corresponding service operator or may attempt to change a channel to a channel provided by a different service operator.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A wavelength management method of an Optical Network Unit (ONU) having a tunable receiver in a Time and Wavelength Division Multiplexing-Passive Optical Network (TWDM-PON) in which a service is provided through multiple channels, the wavelength management method comprising:
setting a wavelength of the tunable receiver as a first channel to receive a physical synchronization signal from an Optical Line Terminal (OLT);
extracting either or both service utilization information and service operator information from the physical synchronization signal; and
based on either or both of the service utilization information and the service operator information, determining whether to perform follow-up procedures for activation via the first channel or whether to change the wavelength of the tunable receiver into a second channel.

2. The wavelength management method of claim 1, wherein the service utilization information and the service operator information are included in a Physical Synchronization Block appropriate for downstream (PSBd) header of a Framing Sublayer (FS) frame.

3. The wavelength management method of claim 2, wherein the service utilization information and the service operator information are included in a PON-ID structure of the PSBd header.

4. The wavelength management method of claim 1, wherein the service utilization information and the service operator information are included in a profile Physical Layer Operation, Administration and Maintenance (PLOAM) message.

5. The wavelength management method of claim 1, wherein in a case where the service operator information is different from service operator information stored in the ONU, the ONU determines to change the wavelength of the tunable receiver into the second channel.

6. The wavelength management method of claim 1, wherein in response to the channel utilization information indicating a red state, the ONU determines the wavelength of the tunable receiver into the second channel.

7. A system for supporting wavelength management in a Time and Wavelength Division Multiplexing-Passive Optical Network (TWDM-PON) in which a service is provided via multiple channels, the system comprising:
an Optical Network Unit (ONU) having a tunable receiver; and
an Optical Line Terminal (OLT) configured to transmit a physical synchronization signal to communicate with the ONU,
wherein the physical synchronization signal comprises either or both service utilization information and service operator information.

8. The system of claim 7, wherein the OLT is further configured to:
set a wavelength of the tunable receiver to be a first channel to receive the physical synchronization signal; and
based on either or both the service utilization information and the service operator information, determine whether to proceed whether to perform follow-up procedures for activation via the first channel or whether to change the wavelength of the tunable receiver into a second channel.

9. The system of claim 7, wherein the service utilization information and the service operator information are included in a Physical Synchronization Block appropriate for downstream (PSBd) header of a Framing Sublayer (FS) frame.

10. The system of claim 9, wherein the service utilization information and the service operator information are included in a PON-ID structure of the PSBd header.

11. The system of claim 7, wherein the service utilization information and the service operator information are included in a profile Physical Layer Operation, Administration and Maintenance (PLOAM) message.

12. An Optical Network Unit (ONU) for supporting wavelength management in a Time and Wavelength Division Multiplexing-Passive Optical Network (TWDM-PON) in which a service is provided via multiple channels, wherein the ONU is configured to:
comprising a tunable receiver;
setting a wavelength of the tunable receiver to be a first channel to receive a physical synchronization signal from an Optical Line Terminal (OLT);
extracting either or both service utilization information and service operator information from the physical synchronization signal; and
based on either or both the service utilization information and the service operator information, determine whether to perform follow-up procedures for activation using the first channel or to change the wavelength of the tunable receiver into a second channel.

13. The ONU of claim 12, wherein the service utilization information and the service operator information are included in a Physical Synchronization Block appropriate for downstream (PSBd) header of a Framing Sublayer (FS) frame.

14. The ONU of claim 13, wherein the service utilization information and the service operator information are included in a PON-ID structure of the PSBd header.

15. The ONU of claim 15, wherein the service utilization information and the service operator information are included in a profile Physical Layer Operation, Administration and Maintenance (PLOAM) message.

16. The ONU of claim 12, wherein the ONU is further configured to, in response to the service operator information being different from service operator information stored in the ONU, change the wavelength of the tunable receiver into the second channel.

17. The ONU of claim 12, wherein the ONU is further configured to, in response to the channel utilization information indicating a red state, change the wavelength of the tunable receiver into the second channel.
